(19) United States
(12) Patent Application Publication
(10) Pub. No.: US 2023/0227756 A1
(43) Pub. Date: Jul. 20, 2023

(54) METHOD OF MAKING A SPRAY-DRIED LAUNDRY DETERGENT PARTICLE

(71) Applicant: The Procter & Gamble Company, Cincinnati, OH (US)

(72) Inventor: Andres Arturo MARTINEZ, NEWCASTLE UPON TYNE (GB)

(21) Appl. No.: 18/093,640

(22) Filed: Jan. 5, 2023

(30) Foreign Application Priority Data
Jan. 14, 2022 (EP) 22151657.8

(51) Int. Cl. C11D 3/37; C11D 11/00; C11D 11/02; C11D 1/22; C11D 3/08; C11D 17/06

(52) U.S. Cl. CPC C11D 3/3703; C11D 1/22; C11D 3/08; C11D 11/02; C11D 11/0017; C11D 17/06

(57) ABSTRACT

A method of making a spray-dried laundry detergent particle, wherein the method includes the steps: (a) forming an aqueous laundry detergent slurry, wherein the slurry includes: (i) from 1 wt% to 40 wt% anionic detersive surfactant; (ii) from 0.1 wt% to 3.5 wt% polyepoxy succinic acid polymer; and (iii) from 10 wt% to 80 wt% water, and (b) spray drying the slurry formed in step (a) to form a spray-dried laundry detergent particle.

### FIELD OF THE INVENTION

The present invention relates to a method of spray-drying. The method increases the rate of surface drying of the particle. The spray-dried laundry detergent particles made by the method have good dissolution, good residue profiles, are more aesthetically pleasing and are easier to dose

### BACKGROUND OF THE INVENTION

Detergent manufacturers use spray-drying as a means to make detergent particles. Care needs to be taken during the spray-drying process to ensure that the bulk density and particle size of the spray-dried particle is controlled. Low bulk densities and narrow particle size distributions are preferred: such spray-dried particles have good dissolution, good residue profiles, are more aesthetically pleasing and are easier to dose. Detergent manufacturers continue to seek improvements to bulk density and particle size control during the spray-drying process.

The inventors have found that introducing low levels of polyepoxy succinic acid polymer into the anionic detersive surfactant slurry during the spray-drying process results in faster surface drying of the spray-dried particle.

The rate of surface drying is measured as the time taken to reach a rate of moisture loss of zero, which occurs when the surface of the spray-dried particle is sufficiently dried to prevent internal moisture from escaping into the surrounding environment. Having the surface of the spray-dried particles dry at such faster rates results in spray-dried particles having low bulk densities and narrow particle size distributions.

Without wishing to be bound by theory, it is believed that the internal moisture entrapped within the surface dried particle leads to lower bulk densities. Furthermore, having the particle surface dry faster reduces the chance of slurry droplet coalescence, which in turn reduces the amount of oversized spray-dried particles and narrows the particle size distribution.

The method of the present invention ensures fast surface drying of the spray-dried particle and provides spray-dried particles having good dissolution, good residue profiles, are more aesthetically pleasing and are easier to dose

### SUMMARY OF THE INVENTION

The present invention provides a method of making a spray-dried laundry detergent particle, wherein the method comprises the steps: (a) forming an aqueous laundry detergent slurry, wherein the slurry comprises: (i) from 1 wt% to 40 wt% anionic detersive surfactant; (ii) from 0.1 wt% to 3.5 wt% polyepoxy succinic acid polymer; and (iii) from 10 wt% to 80 wt% water, and (b) spray drying the slurry formed in step (a) to form a spray-dried laundry detergent particle.

### DETAILED DESCRIPTION OF THE INVENTION

### The Method of Making a Spray-dried Laundry Detergent Particle

The method comprises the steps: (a) forming an aqueous laundry detergent slurry, wherein the slurry comprises: (i) from 1 wt% to 40 wt% anionic detersive surfactant; (ii) from 0.1 wt% to 3.5 wt% polyepoxy succinic acid polymer; and (iii) from 10 wt% to 80 wt% water, and (b) spray drying the slurry formed in step (a) to form a spray-dried laundry detergent particle.

### Step (a) Forming an Aqueous Laundry Detergent Slurry

Step (a) forms an aqueous laundry detergent slurry.

### Step (b) Spray-Drying the Slurry

Step (b) spray dries the slurry formed in step (a) to form a spray-dried laundry detergent particle.

Preferably, during step (b) the slurry is spray-dried in a spray-drying tower having an air inlet temperature of at least 150° C., preferably at least 180° C., or at least 200° C., or even at least 250° C.

### The Aqueous Laundry Detergent Slurry

The slurry comprises: (i) from 1 wt% to 40 wt% anionic detersive surfactant; (ii) from 0.1 wt% to 3.5 wt% polyepoxy succinic acid polymer; and (iii) from 10 wt% to 80 wt% water.

Preferably, the slurry comprises from 0.1 wt% to 3.5 wt%, or from 0.2 wt% to 3.0 wt%, or from 0.3 wt% to 2.5 wt%, or from 0.5 wt% to 2.0 wt% polyepoxy succinic acid polymer.

Preferably, the slurry comprises:
(i) from 10 wt% to 30 wt% anionic detersive surfactant;
(ii) from 0.3 wt% to 2.5 wt% polyepoxy succinic acid polymer; and
(iii) from 20 wt% to 40 wt% water.

Preferably, the slurry comprises silicate salt. Preferably, the silicate salt is sodium silicate salt. Preferably, the slurry comprises from 1.0 wt% to 20 wt%, or from 5.0 wt% to 15 wt% silicate salt.

Preferably, the slurry comprises from 10 wt% to 30 wt% anionic detersive surfactant.

Preferably, the anionic detersive surfactant comprises linear alkylbenezene sulphonate.

Preferably, the slurry comprises from 1.0 wt% to 40 wt%, or from 10 wt% to 30 wt% linear alkylbenzene sulphonate.

### The Spray-Dried Particle

The spray-dried particle comprises anionic detersive surfactant and polyepoxy succinic acid polymer.

Preferably, the spray-dried particle formed in step (b) has a bulk density of less than 600 g/l, or less than 550 g/l, or less than 500 g/l, or less than 450 g/l.

Preferably, the spray-dried particle formed in step (b) has a particle size distribution such that at least 90 wt%, or at least 95 wt%, or at least 99 wt% of the particles have a particle size of not greater than 850 µm (850 µm or less).

The spray-dried particle can be incorporated into a laundry detergent composition. Suitable laundry detergent compositions are described in more detail below.

The spray-dried particle may comprise other detergent ingredients. Suitable detergent ingredients are described in more detail below.

### Polyepoxy Succinic Acid Polymer

The polyepoxy succinic acid polymer (PESA) polymer preferably has a structure described below:

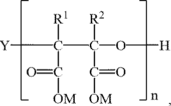

wherein:
R¹ and R² are independently selected from H, C₁-C₆ alkyl, —OH, —COOM;
M is selected from H, Na, K, NH₄, or substituted ammonium;
Y is selected from —OH, —OR′, —NH₂, —NHR′, —NR′₂, in which R′ is selected from C₁-C₆ alkyl; and
n is from 2 to 20.

Preferably:
R¹ and R² are independently selected from H, CH₃;
M is selected from H, Na;
Y is selected from —OH, —OR′, —NH₂, in which R′ is selected from C₁-C₆ alkyl; and
n is from 2 to 15.

More preferably:
R¹ and R² are both H;
M is selected from H, Na;
Y is selected from —OH; and
n is from 2 to 10.

Most preferably, the polyepoxy succinic acid polymer can be represented by structure below:

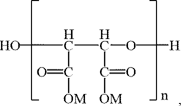

wherein M is H or Na, and n is from 2-10.

The polyepoxy succinic acid polymer maybe used as singulary or in mixture. The “n” represents an average number. In one embodiment, when polyepoxy succinic acid polymer polymer is a mixture, the polymer sample may be dominated by samples with n from 2-7, more preferable from 3-6.

Polymers derived from the following 1-oxacyclopropane-2,3-dicarboxylic acids are suitable polyepoxy succinic acid polymers:
1-oxacyclopropane-cis-2,3-dicarboxylic acid;
1-oxacyclopropane-trans-2,3-dicarboxylic acid;
1-oxacyclopropane-2,2,3-tricarboxylic acid;
1-oxacyclopropane-2,2,3,3-tetracarboxylic acid;
1-oxacyclopropane-2,3-dimethyl-2,3-dicarboxylic acid; and
any combination thereof.

Of these above acids, the most preferred are the polymers derived from 1-oxacyclopropane-cis-2,3-dicarbxylic acid, with n from 2 to about 8 being most preferred.

A most preferred polyepoxy succinic acid polymer can be identified using CAS number: 51274-37-4, or 109578-44-1.

Alternative names of the preferred polymers include:
polyoxirane-2,3-dicarboxylic acid;
2,3-oxiranedicarboxylic acid homopolymer;
2,3-oxiranedicarboxylic acid homopolymer;
poly(1-oxacyclopropane-2,3-dicarboxylic acid); and
epoxysuccinic acid homopolymer.

Suitable polyepoxy succinic acid polymers are commercially available from various suppliers, such as Aquapharm Chemicals Pvt. Ltd (commercial name: Maxinol 600); Shandong Taihe Water Treatment Technologies Co., Ltd (commercial name: PESA), and Sirius International (commercial name: Briteframe PESA).

Laundry Detergent Composition: Suitable laundry detergents are solid, typically granular laundry detergent compositions formed from particles, more typically a solid free-flowing particulate laundry detergent composition. Typically, the solid free-flowing particulate laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co- granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

The laundry detergent composition can be incorporated in a unit dose article, such as a pouch, and may even be incorporated into a sheet or fibres.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

Suitable laundry detergent compositions may have a low buffering capacity. Such laundry detergent compositions typically have a reserve alkalinity to pH 9.5 of less than 5.0 gNaOH/100 g. These low buffered laundry detergent compositions typically comprise low levels of carbonate salt.

Detersive Surfactant: Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic Detersive Surfactant: Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈alkyl alkoxylated sulphate, preferably a C₈₋₁₈alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counterion is sodium.

Non-ionic Detersive Surfactant: Suitable non-ionic detersive surfactants are selected from the group consisting of: C₈₋₁₈alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Cationic Detersive Surfactant: Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

$$\left(\text{R}\right) \left({\text{R}}_{1}\right) \left({\text{R}}_{2}\right) \left({\text{R}}_{3}\right) {\text{N}}^{+} {\text{X}}^{-}$$

wherein, R is a linear or branched, substituted or unsubstituted C₆₋₁₈ alkyl or alkenyl moiety, R¹ and R² are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Zwitterionic Detersive Surfactant: Suitable zwitterionic detersive surfactants include amine oxides and/or betaines.

Polymer: Suitable polymers include carboxylate polymers, soil release polymers, anti-redeposition polymers, cellulosic polymers, care polymers and any combination thereof.

Carboxylate Polymer: The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt% structural units derived from one or more monomers comprising carboxyl groups; (ii) from 1 to less than 49 wt% structural units derived from one or more monomers comprising sulfonate moieties; and (iii) from 1 to 49 wt% structural units derived from one or more types of monomers selected from ether bond-containing monomers represented by formulas (I) and (II):

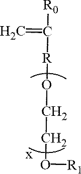

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

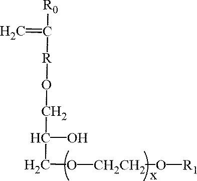

wherein in formula (II), R₀ represents a hydrogen atom or CH₃ group, R represents a CH₂ group, CH₂CH₂ group or single bond, X represents a number 0-5, and R¹ is a hydrogen atom or C₁ to C₂₀ organic group.

It may be preferred that the polymer has a weight average molecular weight of at least 50 kDa, or even at least 70 kDa.

Soil Release Polymer: The composition may comprise a soil release polymer. A suitable soil release polymer has a structure as defined by one of the following structures (I), (II) or (III):
(I) —[(OCHR¹—CHR²)a O—OC—Ar—CO—]_{d}
(II) —[(OCHR³—CHR⁴)b—O—OC—sAr—CO—]ₑ
(III) —[(OCHR⁵—CHR⁶)_{c}—OR⁷]f
wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₈-C₁₈ alkyl or C₂-C₁₀ hydroxyalkyl, or mixtures thereof;
R1, R², R³, R⁴, R⁵ and R⁶ are independently selected from H or C₈-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Anti-redeposition Polymer: Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

Cellulosic Polymer: Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care Polymers: Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach: Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of Hydrogen Peroxide: Suitable sources of hydrogen peroxide include sodium perborate and/or sodium percarbonate.

Bleach Activator: Suitable bleach activators include tetra acetyl ethylene diamine and/or alkyl oxybenzene sulphonate.

Bleach Catalyst: The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

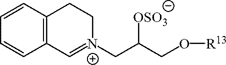

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-formed Peracid: Suitable pre-form peracids include phthalimido-peroxycaproic acid.

Enzymes: Suitable enzymes include lipases, proteases, cellulases, amylases and any combination thereof.

Protease: Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/ Kemira, namely BLAP (sequence shown in Figure 29 of US 5,352,604 with the folowing mutations S99D + S101 R + S103A + V104I + G159S, hereinafter referred to as BLAP), BLAP R (BLAP with S3T + V4I + V199M + V205I + L217D), BLAP X (BLAP with S3T + V4I + V205I) and BLAP F49 (BLAP with S3T + V4I + A194P + V199M + V205I + L217D) - all from Henkel/Kemira; and KAP (Bacillus alkalophilus subtilisin with mutations A230V + S256G + S259N) from Kao.

A suitable protease is described in WO11/140316 and WO11/072117.

Amylase: Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont). A suitable amylase is described in WO06/002643.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

Lipase: Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

Other Enzymes: Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Zeolite Builder: The composition may comprise zeolite builder. The composition may comprise from 0 wt% to 5 wt% zeolite builder, or 3 wt% zeolite builder. The composition may even be substantially free of zeolite builder; substantially free means “no deliberately added”. Typical zeolite builders include zeolite A, zeolite P and zeolite MAP.

Phosphate builder: The composition may comprise phosphate builder. The composition may comprise from 0 wt% to 5 wt% phosphate builder, or to 3 wt%, phosphate builder. The composition may even be substantially free of phosphate builder; substantially free means “no deliberately added”. A typical phosphate builder is sodium tri-polyphosphate.

Carbonate Salt: The composition may comprise carbonate salt. The composition may comprise from 0 wt% to 10 wt% carbonate salt, or to 5 wt% carbonate salt. The composition may even be substantially free of carbonate salt; substantially free means “no deliberately added”. Suitable carbonate salts include sodium carbonate and sodium bicarbonate.

Silicate Salt: The composition may comprise silicate salt. The composition may comprise from 0 wt% to 10 wt% silicate salt, or to 5 wt% silicate salt. A preferred silicate salt is sodium silicate, especially preferred are sodium silicates having a Na₂O—SiO₂ ratio of from 1.0 to 2.8, preferably from 1.6 to 2.0.

Sulphate Salt: A suitable sulphate salt is sodium sulphate.

Brightener: Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN. Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5- triazin-2-yl)];amino } stilbene-2-2′ disulfonate, disodium 4,4′-bis{[(4-anilino-6-morpholino-1,3,5-triazin-2-yl)]amino} stilbene-2-2′ disulfonate, and disodium 4,4′- bis(2-sulfostyryl)biphenyl. A suitable fluorescent brightener is C.I. Fluorescent Brightener 260, which may be used in its beta or alpha crystalline forms, or a mixture of these forms.

Chelant: The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′- disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing Agent: Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

Dye Transfer Inhibitors: Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Perfume: Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

Silicone: Suitable silicones include polydimethylsiloxane and amino-silicones. Suitable silicones are described in WO05075616.

Process for Making the Solid Composition: Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt% of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt% of the agglomerates have a particle size less than 150 micrometers and less than 10 wt% of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Method of Laundering Fabric: The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels._Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

Solid Free-flowing Particulate Laundry Detergent Composition Examples:

| | |
|---|---|
| Ingredient | Amount (in wt%) |
| Anionic detersive surfactant (such as alkyl benzene sulphonate, alkyl ethoxylated sulphate and mixtures thereof) | from 8 wt% to 15 wt% |
| Non-ionic detersive surfactant (such as alkyl ethoxylated alcohol) | from 0.1 wt% to 4 wt% |
| Cationic detersive surfactant (such as quaternary ammonium compounds) | from 0 wt% to 4 wt% |
| Other detersive surfactant (such as zwiterionic detersive surfactants, amphoteric surfactants and mixtures thereof) | from 0 wt% to 4 wt% |
| Carboxylate polymer (such as co-polymers of maleic acid and acrylic acid and/or carboxylate polymers comprising ether moieties and sulfonate moieties) | from 0.1 wt% to 4 wt% |
| Polyethylene glycol polymer (such as a polyethylene glycol polymer comprising polyvinyl acetate side chains) | from 0 wt% to 4 wt% |
| Polyester soil release polymer (such as Repel-o-tex and/or Texcare polymers) | from 0 wt% to 2 wt% |
| Cellulosic polymer (such as carboxymethyl cellulose, methyl cellulose and combinations thereof) | from 0.5 wt% to 2 wt% |
| Other polymer (such as care polymers) | from 0 wt% to 4 wt% |
| Zeolite builder and phosphate builder (such as zeolite 4A and/or sodium tripolyphosphate) | from 0 wt% to 4 wt% |
| Other co-builder (such as sodium citrate and/or citric acid) | from 0 wt% to 3 wt% |
| Carbonate salt (such as sodium carbonate and/or sodium bicarbonate) | from 0 wt% to 20 wt% |
| Silicate salt (such as sodium silicate) | from 0 wt% to 10 wt% |
| Filler (such as sodium sulphate and/or bio-fillers) | from 10 wt% to 70 wt% |
| Source of hydrogen peroxide (such as sodium percarbonate) | from 0 wt% to 20 wt% |
| Bleach activator (such as tetraacetylethylene diamine (TAED) and/or nonanoyloxybenzenesulphonate (NOBS)) | from 0 wt% to 8 wt% |
| Bleach catalyst (such as oxaziridinium-based bleach catalyst and/or transition metal bleach catalyst) | from 0 wt% to 0.1 wt% |
| Other bleach (such as reducing bleach and/or pre-formed peracid) | from 0 wt% to 10 wt% |
| Photobleach (such as zinc and/or aluminium sulphonated phthalocyanine) | from 0 wt% to 0.1 wt% |
| Chelant (such as ethylenediamine-N′N′-disuccinic acid (EDDS) and/or hydroxyethane diphosphonic acid (HEDP)) | from 0.2 wt% to 1 wt% |
| Hueing agent (such as direct violet 9, 66, 99, acid red 50, solvent violet 13 and any combination thereof) | from 0 wt% to 1 wt% |
| Brightener (C.I. fluorescent brightener 260 or C.I. fluorescent brightener 351) | from 0.1 wt% to 0.4 wt% |
| Protease (such as Savinase, Savinase Ultra, Purafect, FN3, FN4 and any combination thereof) | from 0.1 wt% to 0.4 wt% |
| Amylase (such as Termamyl, Termamyl ultra, Natalase, Optisize, Stainzyme, Stainzyme Plus and any combination thereof) | from 0 wt% to 0.2 wt% |
| Cellulase (such as Carezyme and/or Celluclean) | from 0 wt% to 0.2 wt% |
| Lipase (such as Lipex, Lipolex, Lipoclean and any combination thereof) | from 0 wt% to 1 wt% |
| Other enzyme (such as xyloglucanase, cutinase, pectate lyase, mannanase, bleaching enzyme) | from 0 wt% to 2 wt% |
| Fabric softener (such as montmorillonite clay and/or polydimethylsiloxane (PDMS)) | from 0 wt% to 15 wt% |
| Flocculant (such as polyethylene oxide) | from 0 wt% to 1 wt% |
| Suds suppressor (such as silicone and/or fatty acid) | from 0 wt% to 4 wt% |
| Perfume (such as perfume microcapsule, spray-on perfume, starch encapsulated perfume accords, perfume loaded zeolite, and any combination thereof) | from 0.1 wt% to 1 wt% |
| Aesthetics (such as coloured soap rings and/or coloured speckles/noodles) | from 0 wt% to 1 wt% |
| Miscellaneous | balance to 100 wt% |

### EMBODIMENTS OF THE PRESENT INVENTION

The following are embodiments of the present invention

1. A method of making a spray-dried laundry detergent particle, wherein the method comprises the steps:
(a) forming an aqueous laundry detergent slurry, wherein the slurry comprises:
   (i) from 1 wt% to 40 wt% anionic detersive surfactant;
   (ii) from 0.1 wt% to 3.5 wt% polyepoxy succinic acid polymer; and
   (iii) from 10 wt% to 80 wt% water, and
(b) spray drying the slurry formed in step (a) to form a spray-dried laundry detergent particle.

2. A method according to embodiment 1, wherein the slurry comprises from 0.3 wt% to 2.5 wt% polyepoxy succinic acid polymer.

3. A method according to any preceding embodiment, wherein the polyepoxy succinic acid polymer has the structure:

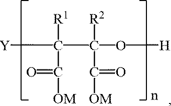

wherein:
R¹ and R² are independently selected from H, C₁-C₆ alkyl, —OH, —COOM;
M is selected from H, Na, K, NH₄, or substituted ammonium; and
Y is selected from —OH, —OR′, —NH₂, —NHR′, —NR′₂, in which R′ is selected from C₁-C₆ alkyl;
n is from 2 to 20.

4. A method according to embodiment 3, wherein the polyepoxy succinic acid polymer has the structure:

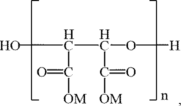

wherein M is H or Na, and n is from 2-10.

5. A method according to any preceding embodiment, wherein the slurry comprises:
(i) from 10 wt% to 30 wt% anionic detersive surfactant;
(ii) from 0.3 wt% to 2.5 wt% polyepoxy succinic acid polymer; and
(iii) from 20 wt% to 40 wt% water.

6. A method according to any preceding embodiment, wherein the slurry comprises silicate salt.

7. A method according to embodiment 6, wherein the silicate salt is sodium silicate salt.

8. A method according to embodiments 6 and 7, wherein the slurry comprises from 1 wt% to 20 wt% silicate salt.

9. A method according to embodiment 8, wherein the slurry comprises from 5 wt% to 15 wt% silicate salt.

10. A method according to any preceding embodiment, wherein the slurry comprises from 10 wt% to 30 wt% anionic detersive surfactant.

11. A method according to any preceding embodiment, wherein the anionic detersive surfactant comprises linear alkylbenezene sulphonate.

12. A method according to embodiment 11, wherein the slurry comprises from 1 wt% to 40 wt% linear alkylbenzene sulphonate.

13. A method according to embodiment 12, wherein the slurry comprises from 10 wt% to 30 wt% linear alkylbenzene sulphonate.

14. A method according to any preceding embodiment, wherein during step (b) the slurry is spray-dried in a spray-drying tower having an air inlet temperature of at least 150° C.

15. A method according to any preceding embodiment, wherein the spray-dried particle formed in step (b) has a bulk density of less than 600 g/l.

### EXAMPLES

### Method to Measure Rate of Moisture Loss of Slurry

Aqueous alkaline slurry composed of sodium sulphate, water, acrylate/maleate co-polymer and miscellaneous ingredients was prepared at 80° C. in a crutcher making vessel. The aqueous slurry was essentially free from zeolite builder and essentially free from phosphate builder. The slurry was mixed for at least 15 minutes to ensure homogeneity of the slurry suspension and then poured into Glass Petri Dishes for Drying in an Oven.

A Slurry slab of a controlled height of 14 mm ±0.5 mm and a controlled diameter of 100 mm ±1mm was created in a glass Petri Dish and its mass was recorded. The Petri Dish was then placed inside an Oven at 70° C., and the mass was recorded every 30 minutes until 300 minutes of drying were completed.

The percentage of moisture loss at time t was calculated as follows:

$$\% M o i s t u r e L o s s = \frac{M a s s S l a {b}_{I N I T I A L} - M a s s S l a {b}_{T i m e = t}}{M a s s S l a {b}_{I N I T I A L}} \times 100$$

Where t = 30, 60, 90, 120, 150, 180, 210, 240, 270 & 300 minutes, respectively.

Subsequently, an expression for the Rate of Moisture Loss was produced by computing the

$$\frac{d \left(\% M o i s t u r e L o s s\right)}{d t}$$

. The time at which the Rate of Moisture Loss reaches a value of zero is reported. Low times are deemed desirable to achieve satisfactory powder quality during the spray-drying process, including high porosity and narrow particle size distribution.

### Rate of Moisture Loss of Inventive and Comparative Slurry

Comparative and inventive detergent slurry were prepared according to composition shown in Table 1. The Rate of Moisture Loss of inventive and comparative slurry was measured according to method as described herein.

Inventive detergent slurry (Detergent Slurry B) manufactured with 1.4% of Polyepoxysuccinic Acid, Sodium Salt (with resulting 2% of Polyepoxysuccinic Acid, Sodium Salt in inventive powder) reached a Rate of Moisture loss of zero 4.3X faster than the comparative slurry manufactured with equal level of Acrylate/Maleate co-polymer (Detergent Slurry A).

Inventive detergent slurry (Detergent Slurry B) manufactured with 1.4% of Polyepoxysuccinic Acid, Sodium Salt (with resulting 2.0% of Polyepoxysuccinic Acid, Sodium Salt in inventive powder) showed a significantly faster decline in Rate of Moisture loss than comparative slurry manufactured with 4.7% of Polyepoxysuccinic Acid (Detergent Slurry C, with resulting 7.0% Polyepoxysuccinic Acid, Sodium Salt in inventive powder), and comparative slurry manufactured with 9.3% of Polyepoxysuccinic Acid (Detergent Slurry D, with resulting 15.0% Polyepoxysuccinic Acid, Sodium Salt in inventive powder).

TABLE 1

| | | Comparative | Inventive | Comparative | Comparative |
|---|---|---|---|---|---|
| | Component | %w/w DETERGENT SLURRY A | %w/w DETERGENT SLURRY B | %w/w DETERGENT SLURRY C | %w/w DETERGENT SLURRY D |
| Detergent slurry | Sodium silicate salt | 7.6 | 7.6 | 7.1 | 6.6 |
| | Linear alkyl benzene sulphonate | 14.9 | 14.9 | 13.7 | 12.7 |
| | Acrylate/Maleate co-polymer | 1.4 | 0.0 | 0.0 | 0.0 |
| | Polyepoxysuccinic Acid, Sodium Salt | 0.0 | 1.4 | 4.7 | 9.3 |
| | Sodium sulphate | 43.9 | 43.9 | 42.4 | 39.4 |
| | Water | 31.2 | 31.2 | 31.2 | 31.2 |
| | Miscellaneous | 1.0 | 1.0 | 0.9 | 0.8 |
| | Total Parts | 100.0 | 100.0 | 100.0 | 100.0 |
| Resulting powder detergent | Sodium silicate salt | 10.0 | 10.0 | 10.0 | 10.0 |
| | Linear alkyl benzene sulphonate | 20.6 | 20.6 | 20.6 | 20.6 |
| | Acrylate/Maleate co-polymer | 2.0 | 0.0 | 0.0 | 0.0 |
| | Polyepoxysuccinic Acid, Sodium Salt | 0.0 | 2.0 | 7.0 | 15.0 |
| | Sodium sulphate | 64.6 | 64.6 | 59.6 | 51.6 |
| | Water | 1.4 | 1.4 | 1.4 | 1.4 |
| | Miscellaneous | 1.4 | 1.4 | 1.4 | 1.4 |
| | Total Parts | 100.0 | 100.0 | 100.0 | 100.0 |
| | Time for Slurry Slab to reach a Rate of Moisture Loss equal to Zero (minutes) | 336 | 78 | 305 | 298 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making a spray-dried laundry detergent particle, wherein the method comprises the steps:
(a) forming an aqueous laundry detergent slurry, wherein the slurry comprises:
(i) from about 1 wt% to about 40 wt% anionic detersive surfactant;
(ii) from about 0.1 wt% to about 3.5 wt% polyepoxy succinic acid polymer; and
(iii) from about 10 wt% to about 80 wt% water, and
(b) spray drying the slurry formed in step (a) to form a spray-dried laundry detergent particle.

2. A method according to claim 1, wherein the slurry comprises from about 0.3 wt% to about 2.5 wt% polyepoxy succinic acid polymer.

3. A method according to claim 1, wherein the polyepoxy succinic acid polymer has the structure: 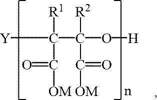
wherein:
R¹ and R² are independently selected from H, C₁-C₆ alkyl, —OH, —COOM;
M is selected from H, Na, K, NH₄, or substituted ammonium; and
Y is selected from —OH, —OR′, —NH₂, —NHR′, —NR′₂, in which R′ is selected from C₁-C₆ alkyl;
n is from about 2 to about 20.

4. A method according to claim 1, wherein the polyepoxy succinic acid polymer has the structure: 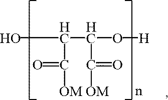
wherein M is H or Na, and n is from about 2-10.

5. A method according to claim 1, wherein the slurry comprises:
(i) from about 10 wt% to about 30 wt% anionic detersive surfactant;
(ii) from about 0.3 wt% to about 2.5 wt% polyepoxy succinic acid polymer; and
(iii) from about 20 wt% to about 40 wt% water.

6. A method according to claim 1, wherein the slurry comprises silicate salt.

7. A method according to claim 1, wherein the silicate salt is sodium silicate salt.

8. A method according to claim 1, wherein the slurry comprises from about 1 wt% to about 20 wt% silicate salt.

9. A method according to claim 1, wherein the slurry comprises from about 5 wt% to about 15 wt% silicate salt.

10. A method according to claim 1, wherein the slurry comprises from about 10 wt% to about 30 wt% anionic detersive surfactant.

11. A method according to claim 1, wherein the anionic detersive surfactant comprises linear alkylbenezene sulphonate.

12. A method according to claim 1, wherein the slurry comprises from about 1 wt% to about 40 wt% linear alkylbenzene sulphonate.

13. A method according to claim 1, wherein the slurry comprises from about 10 wt% to about 30 wt% linear alkylbenzene sulphonate.

14. A method according to claim 1, wherein during step (b) the slurry is spray-dried in a spray-drying tower having an air inlet temperature of at least about 150° C.

15. A method according to claim 1, wherein the spray-dried particle formed in step (b) has a bulk density of less than about 600 g/l.
